(19) United States
(12) Patent Application Publication
(10) Pub. No.: US 2004/0224691 A1
(43) Pub. Date: Nov. 11, 2004

(54) Handoff system and method

(76) Inventor: Zion Hadad, Rishon Lezion (IL)

Correspondence Address: ZION HADAD, 48 HAALMOGIM ST., RISHON LEZION, IL

(21) Appl. No.: 10/844,526

(22) Filed: May 13, 2004

(30) Foreign Application Priority Data
May 9, 2003 (IL) 155828
May 9, 2004 (WO) PCT/IL04/00387

(51) Int. Cl. H04Q 7/20

(52) U.S. Cl. 455/442; 455/437; 455/440

(57) ABSTRACT

A soft handoff system for a wideband wireless cellular network, comprises diversity reception enhancement means, channel equalization for coherent processing means and coherent summing means. The downlink system further includes means for implementing diversity, allowing two base stations to concurrently transmit the same information, with coherent summing at the mobile receiver. A soft handoff method for a wideband wireless cellular network, comprises: 1) The mobile subscriber continuously evaluates the quality of the channel; When it deteriorates, the mobile requests a handoff; 2) the base station activates diversity transmissions from one or more additional base stations, which transmit the same messages/packets to the mobile; The subcarriers allocation is transmitted to the mobile; 3) the mobile adds coherently the receptions from two or more base stations, for improved SNR.

### CROSS-REFERENCE TO RELATED APPLICATIONS

The present application is related to, and claims priority from, the patent application No. 155828 filed on 9 May 2003 in Israel, and the PCT application No. PCT/IL 2004/000387 filed on 9 May 2004, both entitled “Handoff system and method”.

### FIELD OF THE INVENTION

The present invention relates to handoff systems in a wideband wireless cellular network, and more particularly to such systems using soft handoff with diversity reception enhancement and channel equalization for coherent processing.

### BACKGROUND OF THE INVENTION

As a mobile subscriber moves away from a first base station towards a second base station in a cellular network, there are problems relating to handoff, that is the transfer of the subscriber from communicating with the first base station to communicating with the second.

A possible problem is instability in the handoff region—due to fading and attenuation at the cell boundary, a decision may be issued to switch to the second base station, followed after a short time interval with a decision to switch back to the first base station. The process may repeat itself many times, as the relative power from each base station fluctuates randomly.

This rather erratic behavior may result in an unnecessary loading of the system. It may also result in loss of communications for some time.

Another problem is that at the boundary between one cell and another, there is a maximal attenuation for the RF path to both base stations. Although maximal power transmission may be used, this may not be enough. A lower level of performance may result, as the mobile subscriber may not be able to communicate satisfactorily with any of the base stations.

Yet another problem at handover, when the cellular backbone is IP based, is the capability of multi-lateral communications to coordinate activities relating to handoff.

The invention relates to wideband communication systems, for example cellular point-to-multipoint (PMP) networks, all operating within the same frequency channel.

A single PMP sector may contain one Base-Station (BS) and multiple Subscriber Units (SU). The network topology may contain multiple BSs, each controlling one or more PMP sectors. The transmission from the BS to the SU is referred as Downlink, and the transmission from the SU to the BS is referred as Uplink.

The invention covers OFDMA PHY layer and PMP network topology and is suitable both for fixed and mobile environment and provides method of using multiple BS transmitters operating in partially overlapping areas using a single frequency channel for downlink transmissions for all the BSs/sectors.

Unlike FDMA systems, in which the channel is separated into disjoint sub-frequencies that may be allocated separately, and in each allocation only part of the bandwidth is used, in OFDMA systems the channel is separated into sub-channels, each sub-channel may be spread over the entire bandwidth, by allocating the subcarriers used by a sub-channel on the entire bandwidth. This provides the OFDMA systems with good frequency diversity property and channel usage. There is no need for frequency separation between sub-channels, they are interleaved one with the other.

There is a problem of interference at a Subscriber Unit (SU) resulting from transmissions from other Base Stations (BS), in networks using Orthogonal Frequency Division Multiple Access (OFDMA).

When multiple BS transmitters use the same frequency channel for downlink and/or uplink transmission, some of the SUs may suffer from severe interference.

This happens because these SUs receive downlink transmissions from more than one BS, at comparable power levels. FIG. 1 depicts this situation, where a SU 11 located in one of the overlap regions 12, 13 may receive downlink transmissions from more than one BS 14, 15 (or 14, 16 respectively) at comparable power levels.

The interference problem is more difficult to solve in novel OFDMA systems, wherein adjacent base stations use the whole subchannels.

In older FDMA systems (see FIG. 2), the channel is separated into disjoint sub-channels, four in this example. These include the channels C1, C2, C3, C4 in the frequency domain, that may be allocated separately, and wherein in each allocation only part of the bandwidth is used. Filtering, together with different channel allocation for each BS, can be used to reduce interference.

In the new OFDMA systems however (for example, as described in IEEE 802.16a or in EN-301-958), the channel is separated into sub-channels, wherein each sub-channel is spread over the entire bandwidth or optional group of sucarrier or clusters.

This scheme achieves improved frequency diversity and channel usage (no need for frequency separation between sub-channels).

For example, in a system according to IEEE 802.16 for mobile applications, the basic synchronization sequence is based on a predefined sequence of PN data that modulates a subset of the sub-carriers. Sub-carriers belonging in this subset are called pilots and are divided in two groups.

One group is of fixed location pilots and the other is of variable location pilots. There is a variable location pilot every twelve sub-carriers, and it is changing position each OFDMA symbol with a cycle repeating every four OFDMA symbols. This is the method used in the IEEE 802.16a OFDMA basic synchronization sequence.

The pilots in OFDMA are used for synchronization as well as for channel estimation, so it is essential to prevent or reduce interference on these sub-carriers, to achieve a high performance downlink.

A PMP sector contains one Base Station (BS) and multiple Subscriber Units (SU). The network topology shall contain multiple BSs, operating within the same frequency band. The transmission from the BS to the SU is referred as Downlink, and the transmission from the SU to the BS is referred as Uplink.

It is an objective of the present invention to overcome various problems relating to handoff in broadband/wideband wireless systems.

### SUMMARY OF THE INVENTION

According to the present invention, there is provided a system and method for improved soft handoff.

The invention includes separate, specific improvements in the uplink and the downlink.

In the downlink, the system includes means for implementing diversity, allowing two base stations to concurrently transmit the same information, with coherent summing at the mobile receiver.

A larger bandwidth is allocated to a mobile in the handoff region. This may appear a waste of bandwidth, but actually it may save system resources by reducing instabilities and unnecessary multiple switching of base stations. It also helps reduce or eliminate dead time (loss of communication) at handoff.

Channel estimation is performed for each of several channels, then the data is corrected in each channel and the received information is summed for reception improvement by diversity.

Coherent addition achieves a significantly larger improvement in the signal to noise ratio (for example 4 times the power vs. 2 times, for equal power input signals).

Usually, fading happens in the channel, however it will happen at different times in two channels with two base stations—the probability of concurrent fading with two base stations is lower.

Therefore, the diversity receiver achieves superior performance in a channel with fading.

Improvements in the operation of the base stations infrastructure allow for messages to be transferred between base stations and be stored there, as the base stations implement the diversity method.

Efficient operation in an IP based network is achieved.

In the uplink, the system includes means for concurrent reception of a mobile in two base stations—the present contact for that mobile, as well as a potential base station to tranfer to.

Using these receptions and coordination between base stations, a smart, planned, more effective handoff can be achieved.

The above improvements can be used with improvements in the wideband wireless system itself, to further improve performance.

Further objects, advantages and other features of the present invention will become obvious to those skilled in the art upon reading the disclosure set forth hereinafter.

### BRIEF DESCRIPTION OF THE DRAWINGS

FIG. 1 illustrates a mobile unit during handoff

FIG. 2 details mobile location by ranging with two or more base stations

FIG. 3 illustrates communication paths between a mobile unit and two base stations

FIG. 4 details diversity communications between a mobile unit and two base stations

FIG. 5 details the structure of a mobile transmitter

FIG. 6 details the structure of a wideband mobile receiver

FIG. 7 details the structure of a wideband base station transmitter

FIG. 8 details the structure of a wideband base station receiver

FIG. 9 details the structure of a channel estimator unit in the receiver

FIG. 10 illustrates SFN operation with 6 groups OFDMA.

FIG. 11 illustrates SFN operation with 3 groups OFDMA.

FIG. 12 details a system for channel estimation and correction.

FIG. 13 illustrates packets flow through an access point.

FIG. 14 illustrates packets flow through a MAC link.

FIG. 15 details an antenna allocation scheme

FIG. 16 details CDMA an initial ranging method

FIG. 17 details CDMA an initial ranging method—SS (part 2)

FIG. 18 details CDMA an initial ranging method—BS

FIG. 19 details a periodic ranging method

FIG. 20 details an implementation of AAS support

FIG. 21 details a method for mapping OFDMA slots

FIG. 22 details a method for mapping OFDMA slots

FIG. 23 details a time plan for one TDD time frame

FIG. 24 illustrates an OFDMA frame

FIG. 25 details a method for FCH channel allocation

FIG. 26 details a method for renumbering the allocated subchannels

FIG. 27 details a method for renumbering the allocated subchannels

FIG. 28 details a method for STC usage

FIG. 29 details a method for STC usage with OFDMA for PUSC

FIG. 30 details an allocation method for AAS_DL_Scan

FIG. 31 details a mapping order for fast feedback

FIG. 32 details mapping of MIMO coefficients

FIG. 33 details a cluster structure

### DETAILED DESCRIPTION OF THE INVENTION

A preferred embodiment of the present invention will now be described by way of example and with reference to the accompanying drawings.

The new system is applicable in TDD or FDD systems.

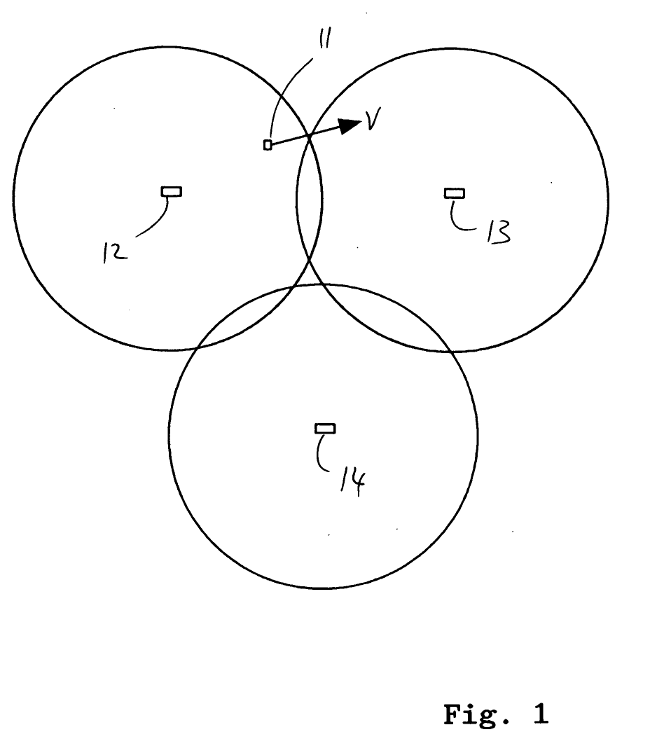

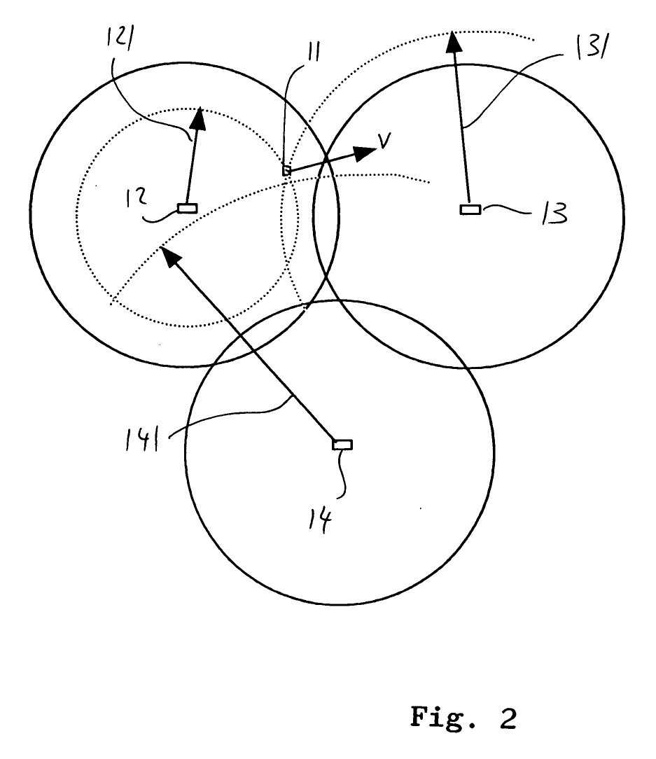

FIG. 1 illustrates a mobile subscriber unit 11 during handoff, with Base Stations (BS) 12, 13, 14 in the area. As illustrated, unit 11 communicates with base station 12 and is in the process of transfering to base 13.

According to the invention, separate handoff processes will occur in the uplink and the downlink.

FIG. 2 details mobile 11 location by ranging with two or more base stations. The circles 121, 131, 141 correspond to measured distances to Base Stations 12, 13, 14 respectively. The mobile location can be found from the distances to two base stations—the location is found at the intersection of the two circles, for example circles 121 and 131.

There may be an ambiguous solution, resulting in two possible locations.

The ambiguity, when present, may be solved in various ways. One way is to use the distance from a third base station, circle 141. The circle 141 may be used for various purposes, for example:

a. To solve ambiguity in location

b. to improve location precision

c. to measure height of unit 11, if relevant.

Distance Measuring Method

In a preferred embodiment, the distance to base stations is measured using the rotation of the pilots in the received signal, as follows:

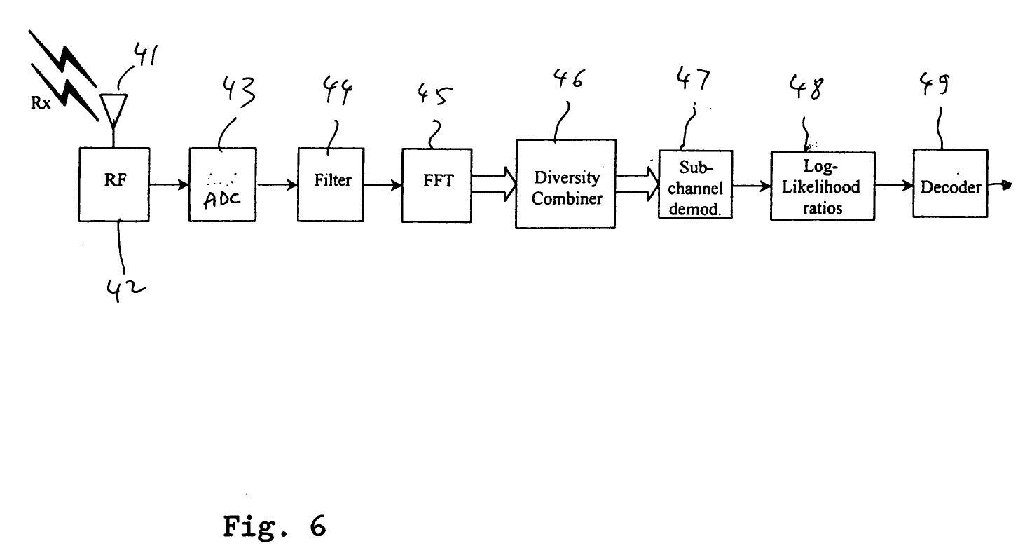

1. The received signal, which has been sampled at a predefined timing, assuming a specific distance from the base station, undergoes a long FFT. See below a description of the receiver with reference to FIG. 6.

2. the phase of pilots is analyzed, to detect a linear phase shift, that is the phase of pilot i is rotated i*deltaPH.

3. the phase rotation corresponds to a time shift (positive or negative delay) of the actual distance to the base station, versus the assumed distance in Step (1).

4. The distance to base station is corrected, adding a correction value computed in Step (3) to the assumed distance in Step (1).

5. The above procedure, Steps (1) to (4), is repeated for all the base stations the mobile communicates with.

Thus, the actual precise distance to two base stations, or possibly more, can be measured in real time at the mobile subscriber unit 11.

End of Method.

This location method can be used for 91 emergency, for H.O. location-based algorithms, for video surveillance systems, etc.

During handoff for example, a mobile subscriber 11 may communicate at the same time with more than one base station. The reception from each base station is on a different channel, that is a different group of subcarriers out of the total subcarriers comprising the channel, as detailed elsewhere in the present application.

The receiver performs a large FFT to concurrently detect all the subcarriers, for all the subchannels, corresponding to received messages from all the base stations transmitting to that unit.

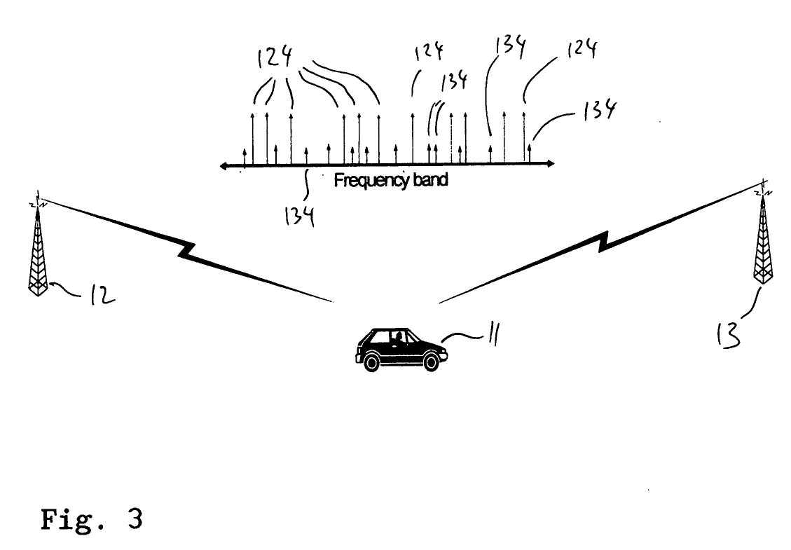

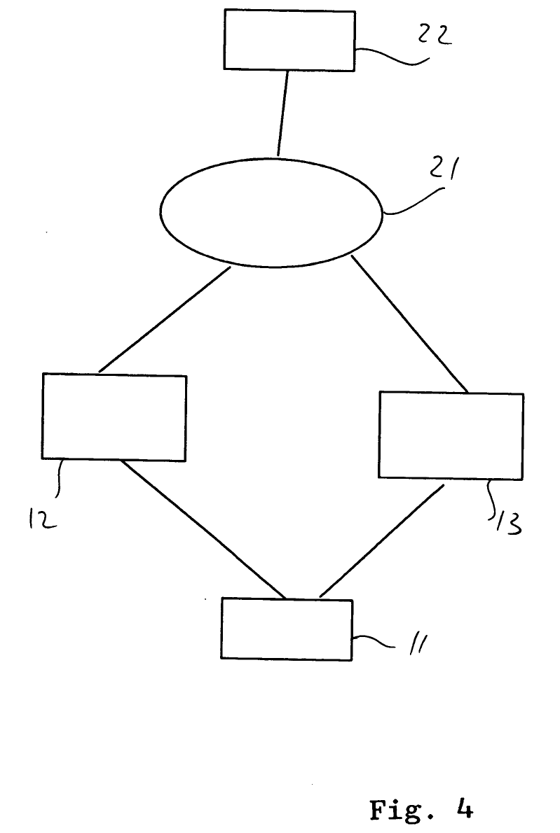

FIG. 3 illustrates communication paths between a mobile unit 11 and two base stations 12, 13.

During handoff, the mobile subscriber unit 11 communicates with two base stations 12, 13 at the same time. each base station is allocated a different channel, each channel comprising a plurality of pilots.

As illustrated, pilots 124 received from base station 12 may have a different amplitude than pilots 134 from base station 13.

The difference in amplitude may result from different distances and other RF propagation factors.

FIG. 4 details diversity communications between a mobile subscriber unit 11 and two base stations 12, 13.

The communication is actually between subscriber unit 11 and a second party 22 through an IP network 21.

In prior art, messages/packets addressed to unit 11 are sent through network 21 to just one base station, for example BS 12. During handoff, the mobile 11 may not receive a packet, which then needs to be re-sent through base station 13 for example. This requires communications between the mobile and the two base stations, as well as between the base stations themselves, a time consuming and resource wasting process.

According to the present invention, each base station further includes means for automatically sending messages dedicated to unit 11, also to another base station 13 that may be the next point of contact in the near future.

The base station further includes means for storing a plurality of packets, that it may be necessary to send to a mobile in case the original channel (with base 12 in this case) fails.

Diversity Channel Allocation Method—Downlink

In the following methods, preferably channel estimation and correction is performed prior to summing two channels.

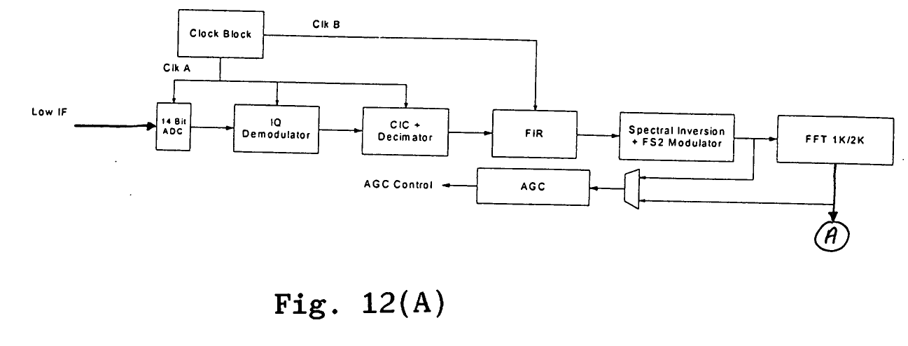

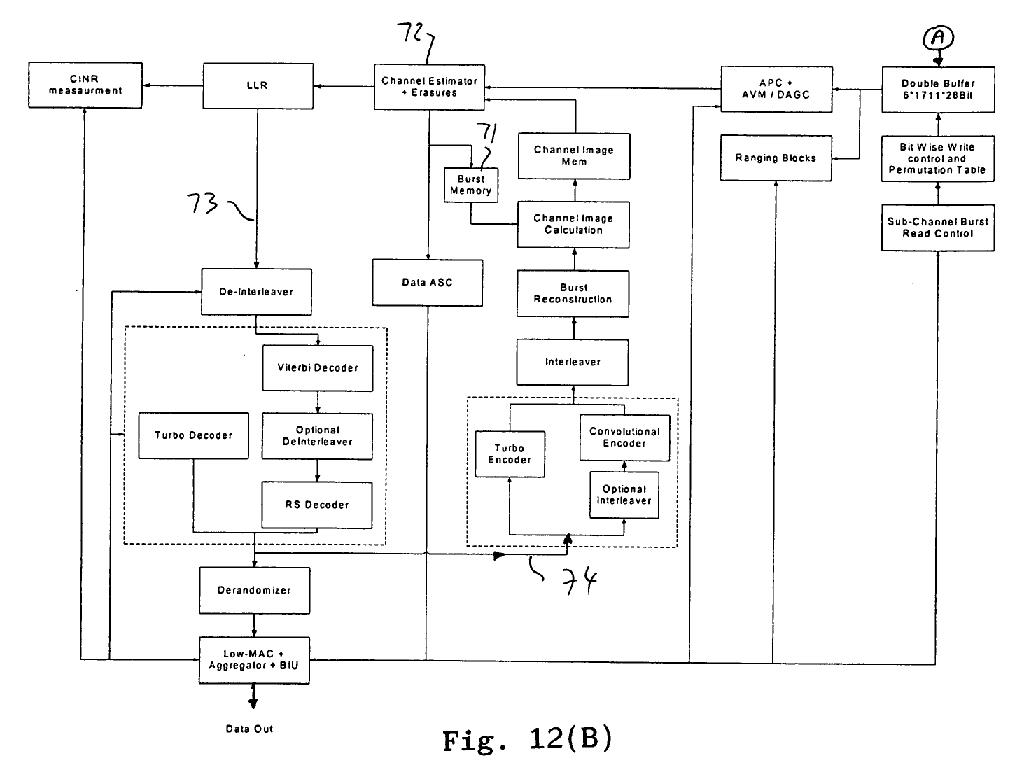

The description referrring to FIG. 12 details a system for implementing channel estimation and correction.

The base stations further include means for coordinating sending a message or packet from more than one base station to a mobile, at the same time.

The coordination process includes performing a decision algorithm for setting up the diversity parameters, to include for example:

1. which base stations will participate in sending diversity messages to a mobile. One or more base stations, for example BS 13 and 14, will send a message/packet to the mobile 11, in addition to base station 12 to which the mobile is assigned at present.

2. what subcarriers will be used by each base station. The subcarriers allocation may depend on the situation at a given time, for each base station or sector therein.

End of Method.

Mobile Location Method

1. The base station 12, now communicating with the mobile 11, sends messages or packets for unit 11, also to another base station, such as 13.

In an IP network, packets are IP encapsulated and are sent to only one destination—base station 12 in this case. At BS 12, the packet is modified and prepared with encapsulation as required to send it to another base station, BS 13 in this example.

Preferably a time stamp is added, to allow the mobile to combine corresponding packets.

2. The base stations set up the subcarriers to be used by the BS 13 for communicating with the mobile.

The subcarrier allocation information is sent to the mobile.

3. The mobile receives the signals, peforms an FFT and forms all the channels as allocated.

4. If signals are received satisfactorily from two or more base stations, the mobile location is computed. If not, the base station is signaled that another diversity channel has to be set up—using for example another base station or another sector in that base station.

End of Method.

Soft Handoff Method 1—Downlink

1. The mobile subscriber continuously evaluates the quality of the channel. When it deteriorates, the mobile requests a handoff.

2. The base station activates diversity transmissions from one or more additional base stations, which transmit the same messages/packets to the mobile. The subcarriers allocation is tranmsitted to the mobile.

3. The mobile adds coherently the receptions from two or more base stations, for improved SNR.

The mobile evaluates the quality of reception from the original base station and from the additional base station.

4. When the reception from the additional base station is reliable and above a preset quality level, the receiver is assigned to that base station and the diversity transmissions end.

End of Method.

Soft Handoff Method 2—Downlink

1. The mobile subscriber continuously computes its location or his SNR. The location or SNR is reported to the base station.

2. The base station and the mobile continuously evaluate the situation, to decide whether a handoff may be required, for example:

a. if the mobile nears the boundary to another cell, as indicated in its measured location/SNR

b. if the quality of service deteriorates

When a handoff is deemed necessary, the base station coordinates

3. When a handoff is deemed necessary, the base station coordinates diversity transmission, for also sending messages/packets to the mobile from a second base station, or possibly from more than one additional base station. Each base station will use a different channel, comprising a different group of pilots.

4. The distance to the other base stations is measured, and the location of the mobile. If there is no good reception from the additional base stations, other paths may be activated—another base station, or another sector from the second base station. Thus, one or more alternate channels to the mobile are established.

End of Method.

Diversity Methods—Downlink

There are two possible methods and systems for diversity:

1. In SFN, two base stations transmit to a mobile using the same subcarriers.

An aggregate chanel estimation may be performed for the combined signal.

In another embodiment, a channel estimate is performed based on subcarriers in the preamble—whereas the data uses the same subcarriers, the pilots in the preamble are different in each BS.

In this case, a channel correction is computed for each BS based on the channels estimate to that BS; the total channel correction function is the sum of the channel correction functions for the two channels corresponding to the two BSs, and this is applied to the received signals.

2. Allocating separate groups of subcarriers for data to each BS. Channel estimation and correction can be performed continuously, even in the data section. IN this case, a channel correction is computed for each BS based on the channels estimate to that BS, and is applied accordingly.

Soft Handoff Method 1—Uplink

1. The base station continuously evaluates the quality of the channel. When it deteriorates, a request for handoff is issued.

2. The base station activates diversity reception at one or more additional base stations, which receive the same messages/packets from the mobile. The subcarriers allocation data for that subscriber is sent to the additional base stations. Although the additional base stations are not assigned to that mobile, they can receive its signals and decode them nevertheless.

3. Messages received at the additional base stations are transmitted to the base station now assigned to the mobile. The original message/packet is reconstructed using the additional information. The message is then sent to its destination.

The total link performance is thus improved.

4. If the reception at the additional base station is not satisfactory, then the original base station tries to set up a channel with another base station or another sector in the base station. The search continues until an alternate channel of good quality is achieved.

4A. (to replace step 4 or in combination therewith): The mobile reports to the base station which other base station or stations is received OK in that mobile, and can thus provide an alternative path for that mobile.

5. When the reception at the additional base station is reliable and above a preset quality level, the mobile is assigned to that base station and the diversity reception ends.

End of Method.

Additional Features of the Handoff Method

ARQ=Automatic Retransmission Queuing

Erred data is identified by the receiver and positively or negatively acknowledged

The transmitter identifies the acknowledgment and retransmits erred data accordingly

MAC level error correction is very effective when channel noise is bursty

ARQ is based on selective-repeat scheme

Only packets with errors are retransmitted

Feedback from the receiver identifies the erred packets

ARQ supports bounded delay services (e.g. multimedia, voice) by limiting the number of retransmissions

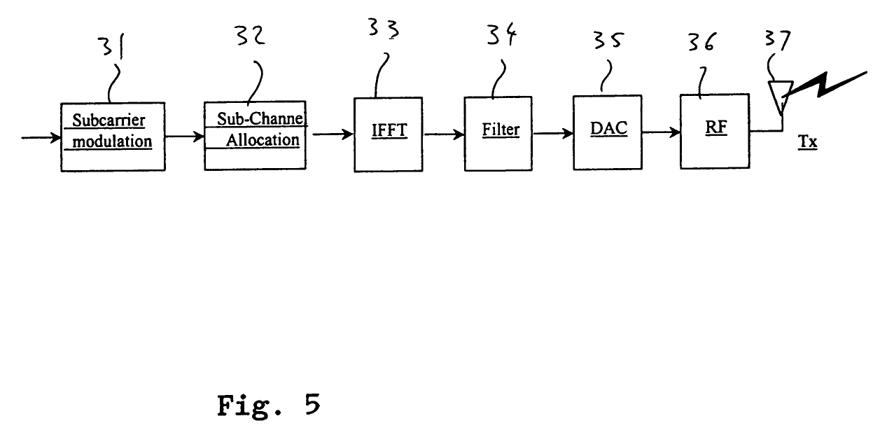

FIG. 5 details the structure of a mobile transmitter, including:

subcarrier modulation unit 31,

sub-channel allocation unit 32,

IFFT (Inverse Fast Fourier Transform) unit 33—also includes a parallel to serial unit.

filter 34

DAC (digital to analog converter) 35

RF (radio frequency) transmit unit 36

antenna 37—a common antenna may be used for transmit and receive.

FIG. 6 details the structure of a wideband mobile receiver, including:

antenna 41—a common antenna may be used for transmit and receive.

RF (radio frequency) receive unit 42

ADC (analog to digital converter) 43

filter 44

FFT (Fast Fourier Transform) unit 45—also includes a serial to parallel unit

diversity combiner 46

subchannel demodulator 47

Log-likelihood ratios unit 48

decoder 49

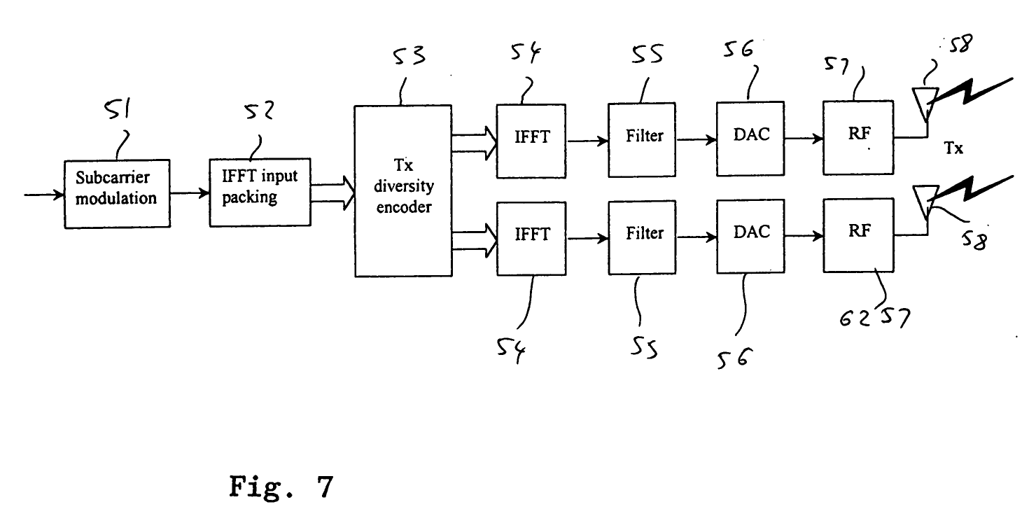

FIG. 7 details the structure of a wideband base station transmitter, including:

subcarrier modulation unit 51

IFFT input packing unit 52

transmit diversity encoder 53

IFFT (Inverse Fast Fourier Transform) units 54

filters 55

DAC (digital to analog converter) 56

RF (radio frequency) transmit units 57

antennas 58

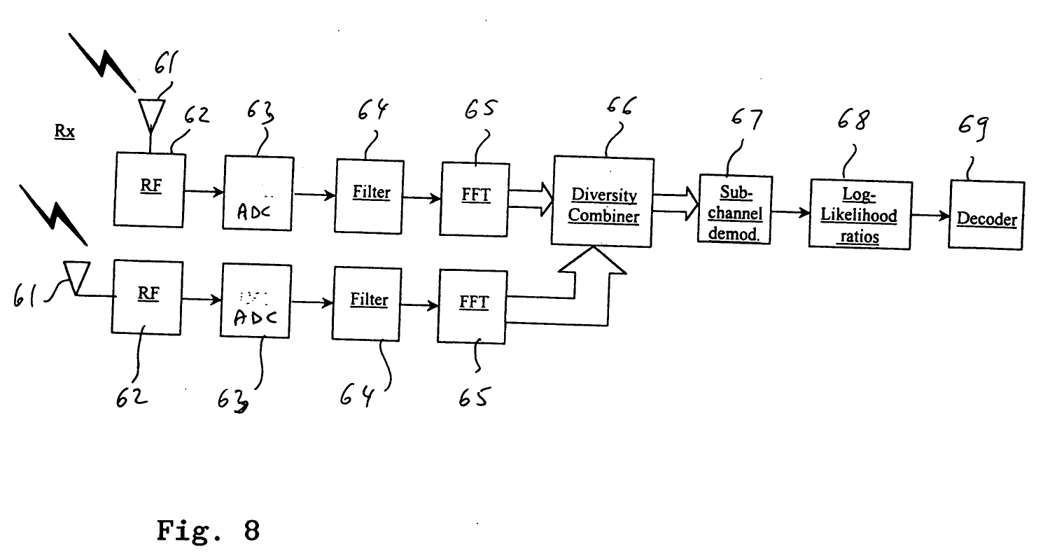

FIG. 8 details the structure of a wideband base station receiver, including:

antennas 61, which may be located at two different base stations

RF (radio frequency) receive units 62

ADC (analog to digital converters) 63

filters 64

FFT (Fast Fourier Transform) units 65

diversity combiner 66

subchannel demodulator 67

Log-likelihood ratios unit 68

decoder 69

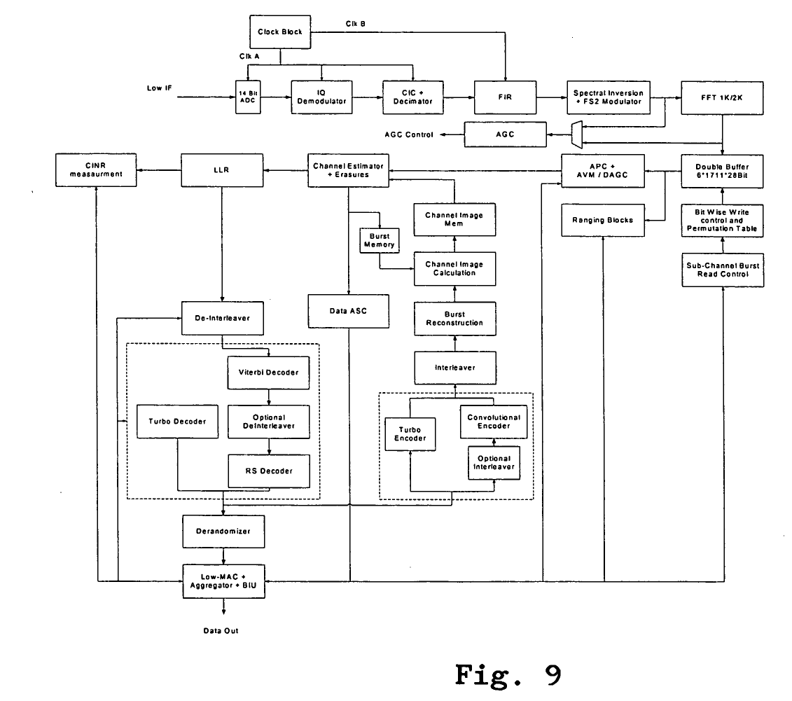

FIG. 9 details the structure of a channel estimator unit in the receiver.

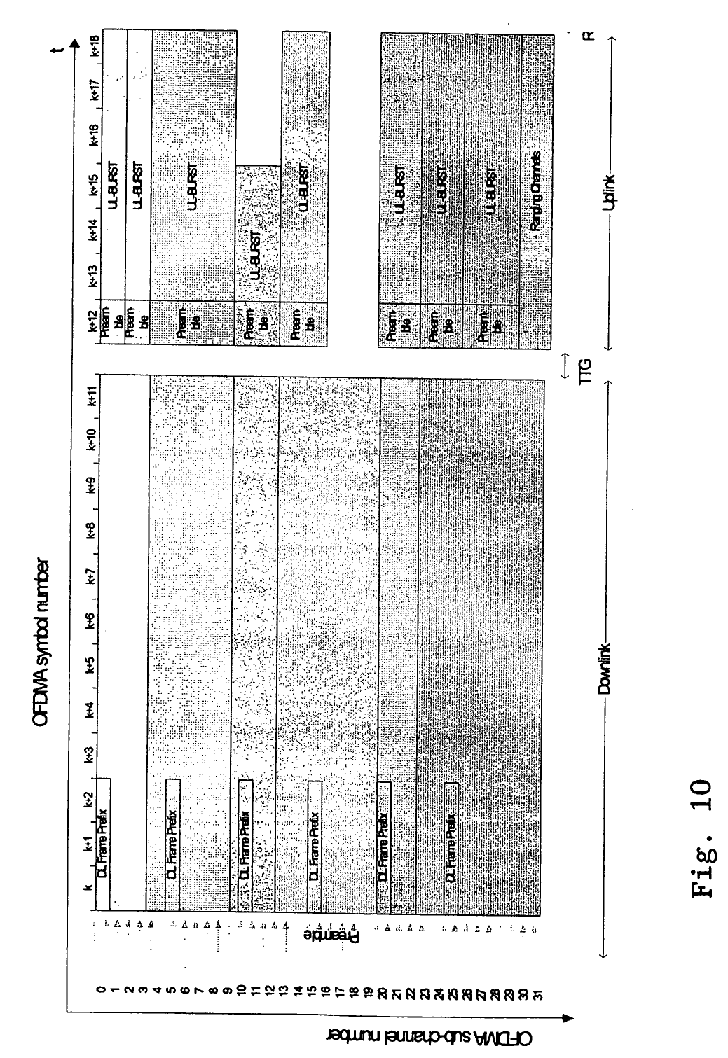

FIG. 10 illustrates SFN operation with 6 groups OFDMA.

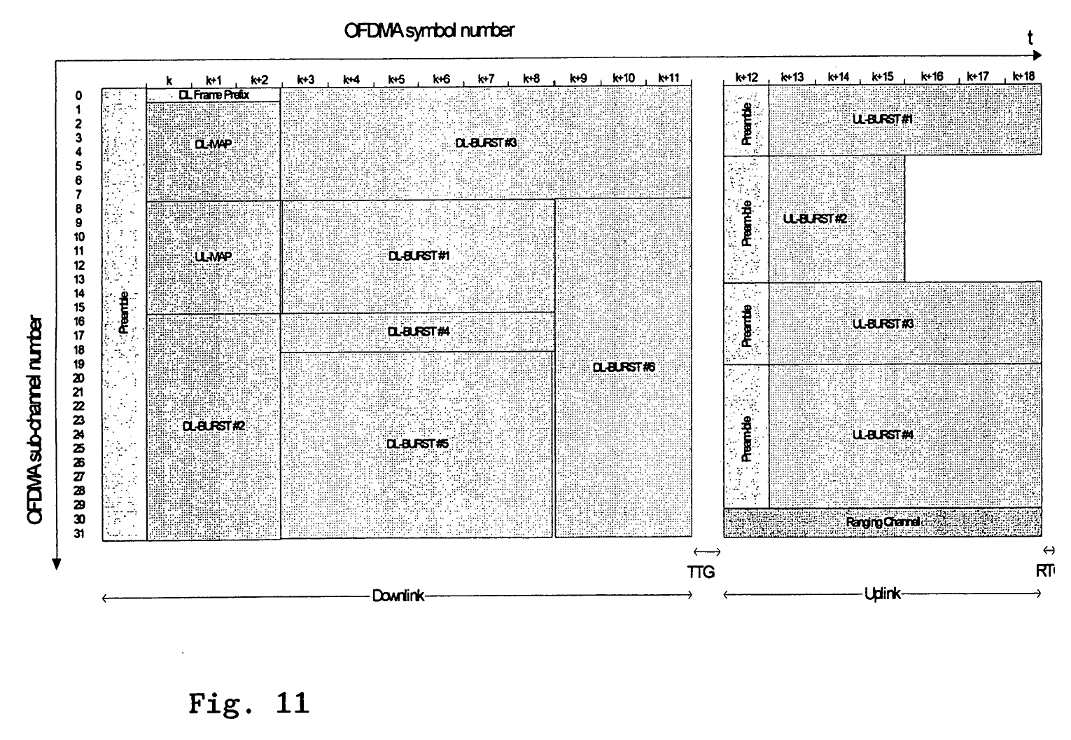

FIG. 11 illustrates SFN operation with 3 groups OFDMA.

FIG. 9 details the structure of a channel estimator unit in the receiver. Prior art estimators operate on a large number of samples, this resulting in a slow time response. Such a unit cannot respond to fast changes in the channel, this causing sometimes a low performance.

The novel structure in the present invention operates faster, to adapt effectively to changes in the channel in real time.

The system includes:

INT 71 input: pilots in preamble

first channel estimator 72

delay 73

CPE 74

second channel estimator 75

CPE 76 inputs: pilots in data section

delay 77

Channel Estimation Method

Stages of channel estimation:

1. Channel measurement by pilots in preamble

2. Comparison with channel measurement by pilots in data

3. Data subcarriers correction according to channel measurement

4. Digital data correction using error correction codes

5. Comparison of corrected data out of step (4) with input data.

Computing a revised channel estimation accordingly.

End of Method.

FIG. 10 illustrates SFN operation with 6 groups OFDMA.

FIG. 11 illustrates SFN operation with 3 groups OFDMA.

Improvements in Wideband Subcarriers Allocation

Improvement—in preamble, each sixth is a jump in pilots. Can be used in SFN or Reuse one—same frequency is reused.

A subscriber receives several signals: six from the closest (best reception) at highest power; six each from other base stations, at lower power.

The pilots are divided among neighbor base stations, 6 to each/every six in subgroups.

Each subscriber performs channel estimation using pilots allocated to each base station, for the channel with each base station which is received.

The range to each base can be estimated from the roundabout time, and/or from the pilots phase rotation as detailed elsewhere in the present disclosure.

Non contention between base stations is achieved, as each BS uses a different subgroup of pilots.

The receiver includes means to compute a quantitative indicator of performance, for example:

SNRi—signal to noise ratio

CHESTi—Channel Estimator for channel i, and/or

SIRi—signal to interference ratio

As a subscriber moves about in the area, it continuously evaluates SNR to each base station it can receive. Other measures of channel quality can be used as well.

If another base is better—then the subscriber will switch to that base station.

Soft Handoff—receives two or more base stations, then decides to switch from one to another.

Subscriber knows his location from two or more distances (two may give two locations—ambiguity; three base stations solve the ambiguity and improve precision of location).

The transmitted signals have a guard time interval. Thus, even if the FFT timing is not precise, it will not include adjacent OFDM symbols.

Time measurements can be performed by FFT on pilots. If the sampling is precisely on time, then the pilots are in phase. A time delay results in rotation of pilot phasors, which is indicative of the time difference relative to the desired timing.

From time measurements—the range (distance) can be computed. From two or more ranges to base stations—the mobile location can be found.

Implementation: large FFT, large dynamic range—will include the strongest signal from a base station, and also one or more weaker signals, from other base stations. If dynamic range is too small—then weaker signals will be supressed because of the quantization error.

In one embodiment—ADC use 10 bits, with a suitable bus width FFT. The FFT may be 1024 point for example.

Modified Wideband Channel

According to the invention, unambiguous synchronization of each SU in each cell can be achieved by a novel system wherein all BSs are synchronized in frequency and time, having the same Frame numbers and slot index, and the same reference clock like GPS or other external synchronization mechanism, which creates a macro-synchronized system for control purposes.

Such an OFDMA system may use the property, that the sub-channels are shared between different BSs.

Furthermore, a large FFT (long OFDM symbols, with duration of at least 4 time than the cell radius electromagnetic propagation time) can be used, to create a large enough Guard Interval (GI), which enables ability of proper reception of information from several BSs in parallel while using same RF receiver and same FFT for all BSs.

Unambiguous synchronization of each SU in each cell can be achieved by a method including transmitting a modified synchronization sequence from each BS.

The BS share a common frequency/timing reference, derived for example from GPS, although other techniques may also be used.

A method for interference reduction will now be detailed, that may be advantageously used to improve performance in IEEE 802.16 in mobile applications, for example.

See FIGS. 5 and 6, for an embodiment relating to four base stations. The pilots may be shared as detailed above referring to OFDMA.

In a preferred embodiment, the pilots retain their position as defined in the IEEE 802.16a specification.

Method for Interference Reduction

Following is an embodiment of a method for interference reduction, that may be used in the IEEE 802.16 or other technologies.

1. Synchronize the BS symbol index to a common reference. For example, a global reference may be used, such as GPS. When using GPS, each BS assumes that symbol indexed 0 has occurred in a predefined time in the past (e.g. Jan. 1, 1990 at 00:00.00). The same OFDMA symbol length must be used in all BS. In another embodiment, a local reference may be used, common to just the base stations in a specific network.

2. Assign to each BS an index in the range 0 to N.

3. Allocating a subset of the synchronization sequence to each BS. Each BS will use its index to determine which subset to transmit. The transmission is synchronized with the other base stations as all the base stations are synchronized to a common reference.

These subsets are predefined and known to all BS and SU.

Each BS may broadcast the network topology to all the SUs, such information contains details about the neighbors cells/sectors, what other frequencies are in use in neighbor cells, or which resources (like sub-channels) are free to be used (for example in Hand Over procedures).

4. The subsets of the synchronization sequence may be disjoint.

5. There may also be a sharing in the time dimension where several BS transmit a synchronization sequence with overlap in the frequency domain, but never do it on the same OFDMA symbol.

6. At the SU allow synchronization on each of the subsets. This is possible as long as

Npilots_in_subset/(Subcarrier_Spacing_NFFT)>Tchannel_delay

End of Method.

The BS keeps track, for each SU, or generally for the downstream channel, of the sub-carriers having a low SNR and of those having a high SNR value. Based on this information, the BS can do one of the following:

a. Not modulating information on carriers that has low SNR

b. Power boosting of the faded carriers on the account of good carriers (done on a user basis).

The receiver in the SU can learn the channel characteristics from the pilots, thus knowing which carriers were boosted, this enabling it to reconstruct the information precisely.

Doing the procedure above for several SU simultaneously, each with different channel behavior, will achieve more efficient power transmission, since this scheme deal with inter sub-channel adaptation, i.e. with low number of sub-carriers that are spread over the band, the transmission is optimized to any channel delay spread behavior.

Adaptive Allocation Method

In an embodiment of the proposed invention, the following adaptive allocation method is used:

1. Coordination between BS for sub-channel allocations, allocation of sub-channels to a BS (number of sub-channels) according to usage load, and traffic profile in the BS.

2. Coordination between BSs of which sub-channel to allocate to which BS. For more efficient Hand-Over procedure.

3. Data and Pilots organization into a sub-channels:

a. Taking the variable pilots and performing the allocation while shifting through time.

b. Fixed pilots are equally divided between the base-stations and are transmitted all the time.

4. Allocating the variable pilots in frequency domain.

5. Separation between different base-stations by using a different Pseudo Noise sequence on the pilots per each Base Station.

6. Usage of Forward Automatic Power Control (FAPC) in the downstream direction.

7. Downlink Adaptive modulation in OFDMA systems.

8. Selective transmission of sub-channels and pilots in the downstream channel, and not using the whole frequency.

9. Selective transmission of sub-carriers within a sub-channel (Downstream) for TDD systems

a. Not modulating information on carriers that has low SNR

b. Power boosting of the faded carriers on the account of good carriers—done on a user basis.

10. Selective transmission of sub-carriers within a sub-channel (Upstream)—for TDD systems. The SU performs steps 9a and 9b when transmitting information to the BS in the uplink direction.

11. Selective transmission of sub-carriers within a sub-channel—Downstream or Upstream for TDD or FDD systems, by using a closed loop procedure.

12. In OFDMA PMP system which are used for mobile environments, and the uplink and downlink channels are allocated, by using an uplink and/or downlink mapping message:

a. A SU may agree on a sleeping interval with the BS, this defines a time interval in which the SU will not demodulate any downstream information.

b. If the BS has information to the SU, it may either discard the information or buffer it and will send it to the SU in its next awakening point (expiration of the next sleeping interval timer).

c. In the awakening times, the BS may assign the SU a specific allocation for synchronization purposes.

The SU may return to normal operation mode in the frame following the awakening frame.

13. Employing Mobile IP protocol over OFDMA PHY layer.

The different frequencies bands in a Multi Frequency Network (MFM) are collected to one Broadband Frequency Network (BFN).

Sub-Channels (30) are divided up to 6 Logical-Bands within (BFM).

The structure enables each Logical-Band to have the frequency diversity properties of the full channel band, but using only a part of the frequency carriers, this will enable the work in a Single Frequency Network (SFN)—reuse of 1.

Sub channels can be shared by other BS and/or Sectors. This requires communications between cells/sectors.

Extra sub channel splitting is optional, and will enable to boost the transmitted carriers at the expense of the un-transmitted carriers (7.7 dB) (will require extra MM resources) and small granularity (24 symbols).

The current DL pilots are divided between up to 6 orthogonal sectors or three. Each pilots group has 6 different whitening PN.

In STC (optional) system each antenna has its own pilots total orthogonal cells/sectors is reduced to three.

Prior to summing two channels, preferably channel estimation and correction is performed. FIGS. 12(A) and 12(B) details a system for implementing channel estimation and correction.

Method of Operation:

1. The signal is received and undergoes receiver stages as detailed.

2. A digital memory 71 holds a prior channel estimate value, for example as measured in a preamble or a historic value.

3. The above estimate is used for channel correction in unit 72

4. The signal is further processed/demodulated, including a deinterleaver followed by a Turbo decoder or Viterbi decoder in path 73.

5. The demodulated, corrected data is output.

6. In a feedback path 74, the corrected data is modulated/encoded back, to reconstruct a corrected received signal (what it should have been).

7. An improved, updated channel estimate is computed, using the corrected data in feedback path 74. This estimate will be used for the next symbol to be received, which may also further update the channel estimate.

End of Method.

Thus, the new system and method achieves a fast response together with good channel estimation and correction.

Note

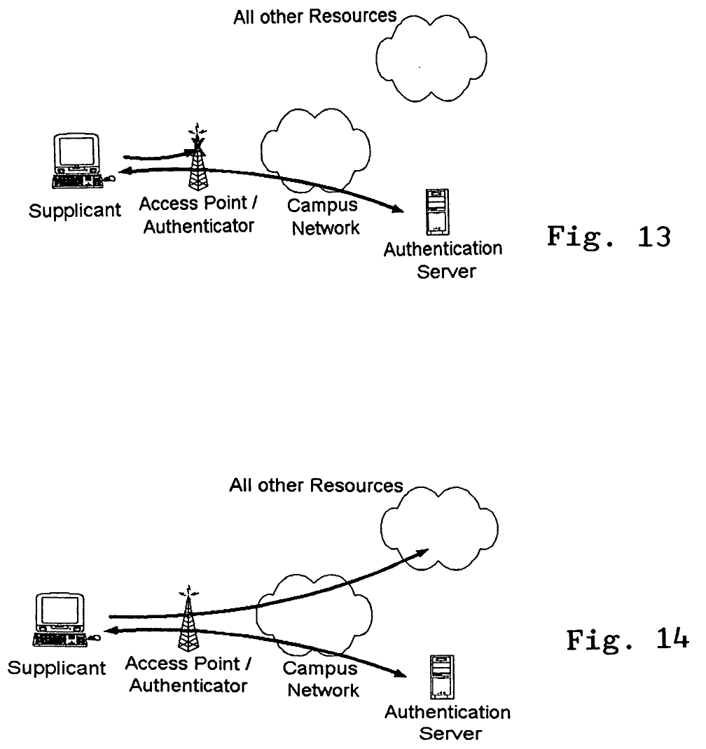

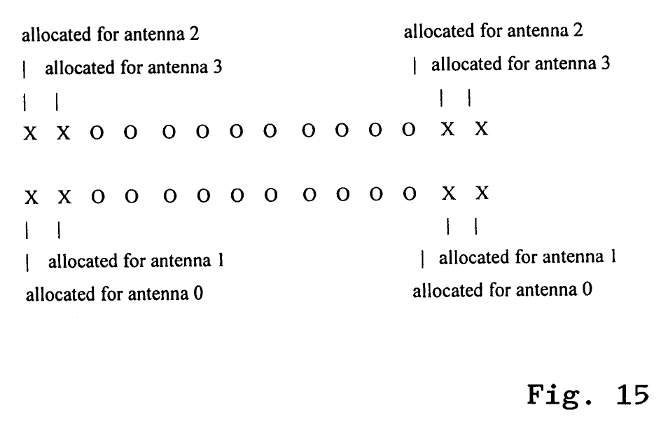

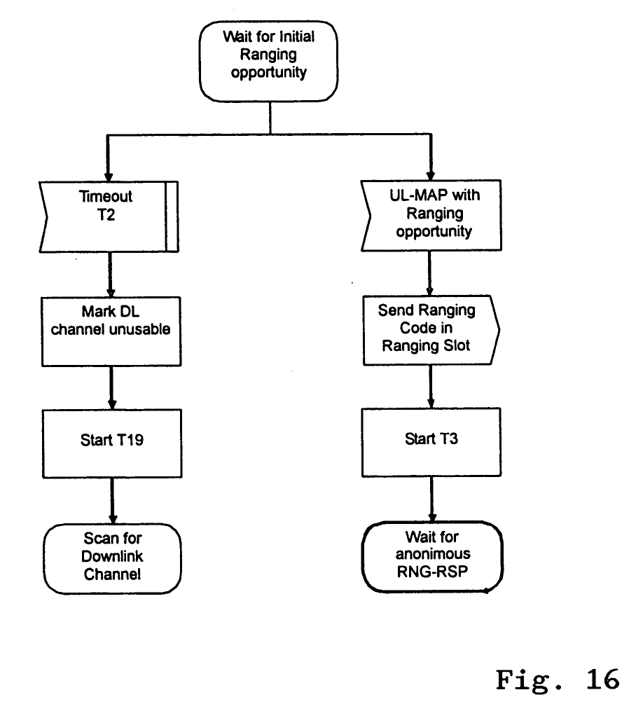

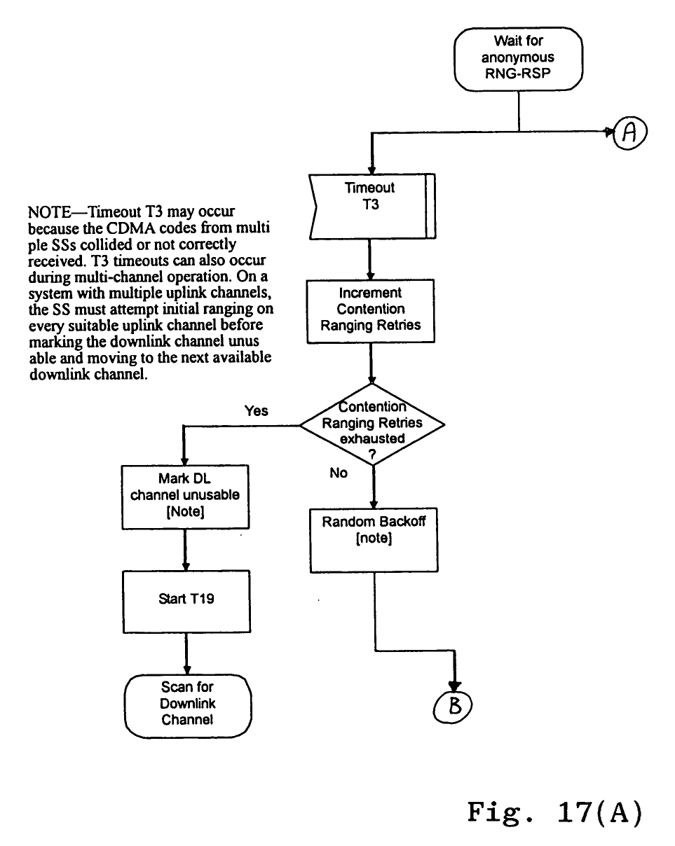

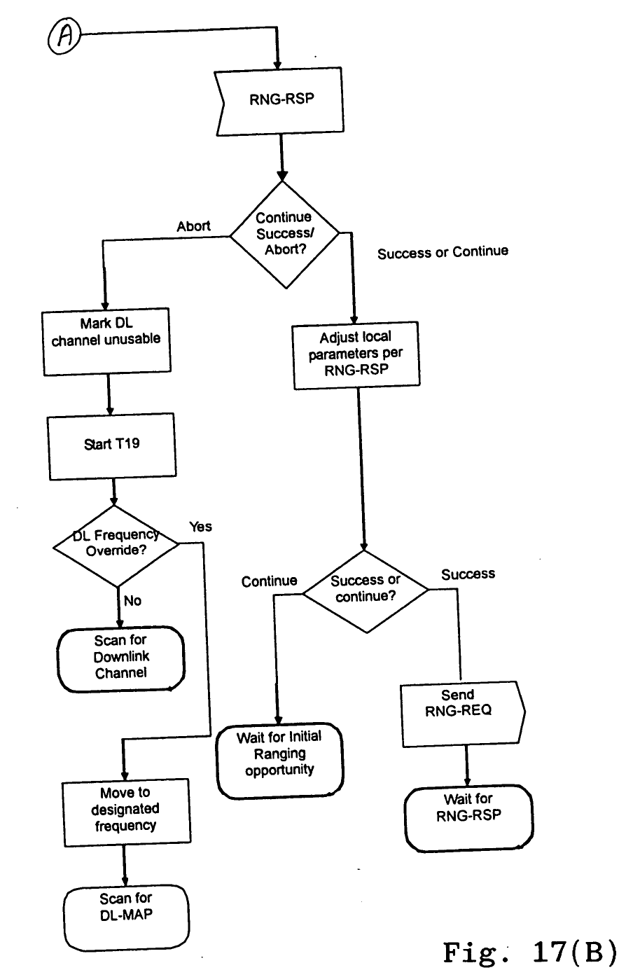

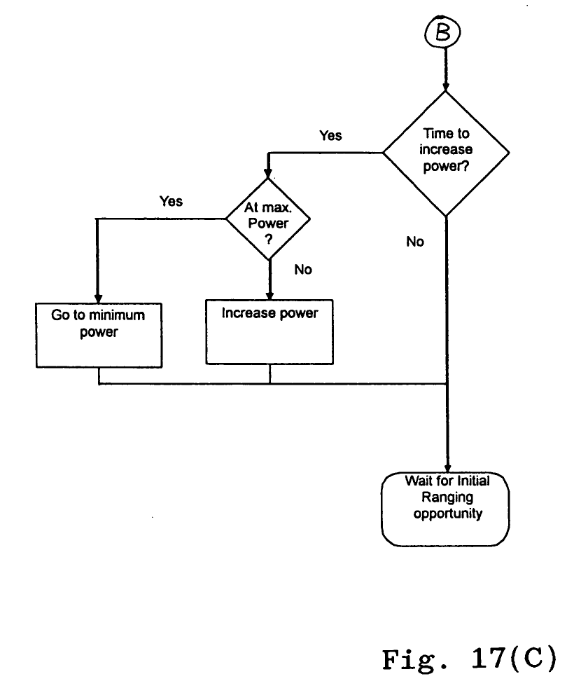

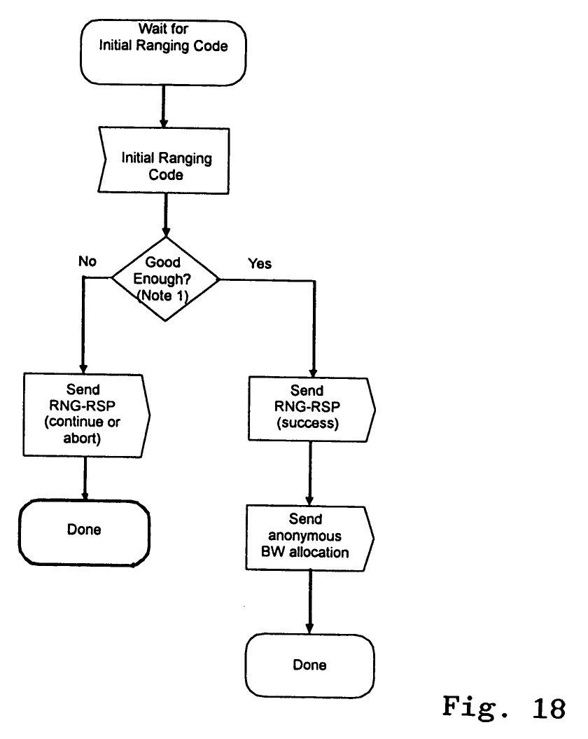

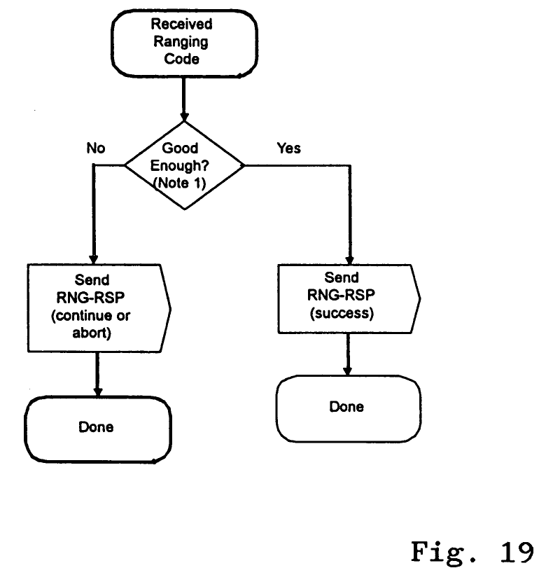

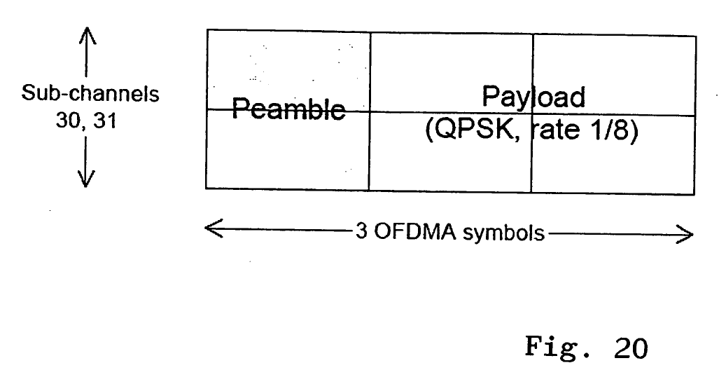

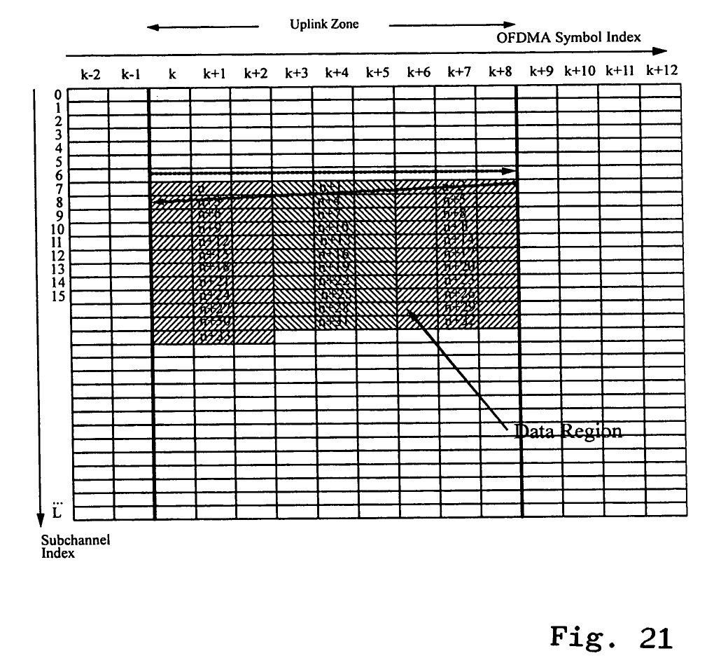

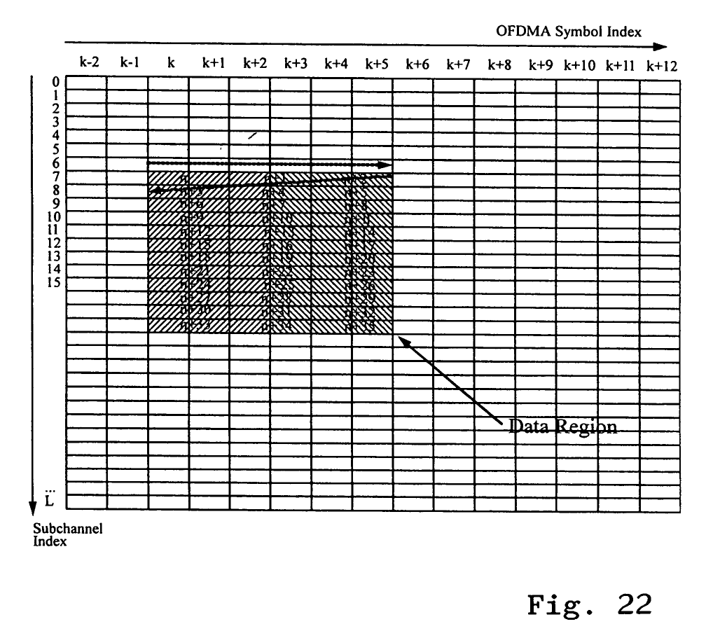

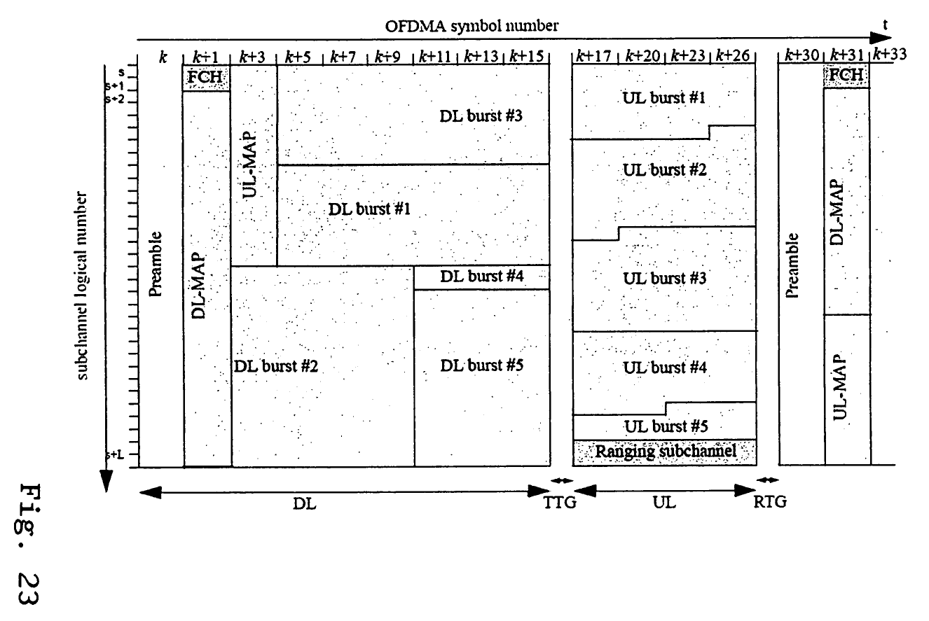

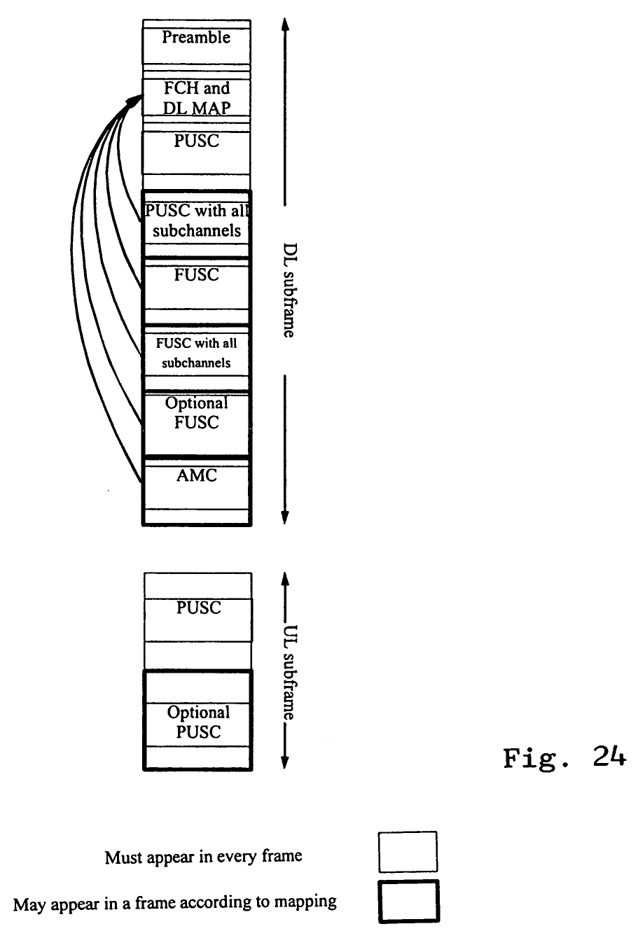

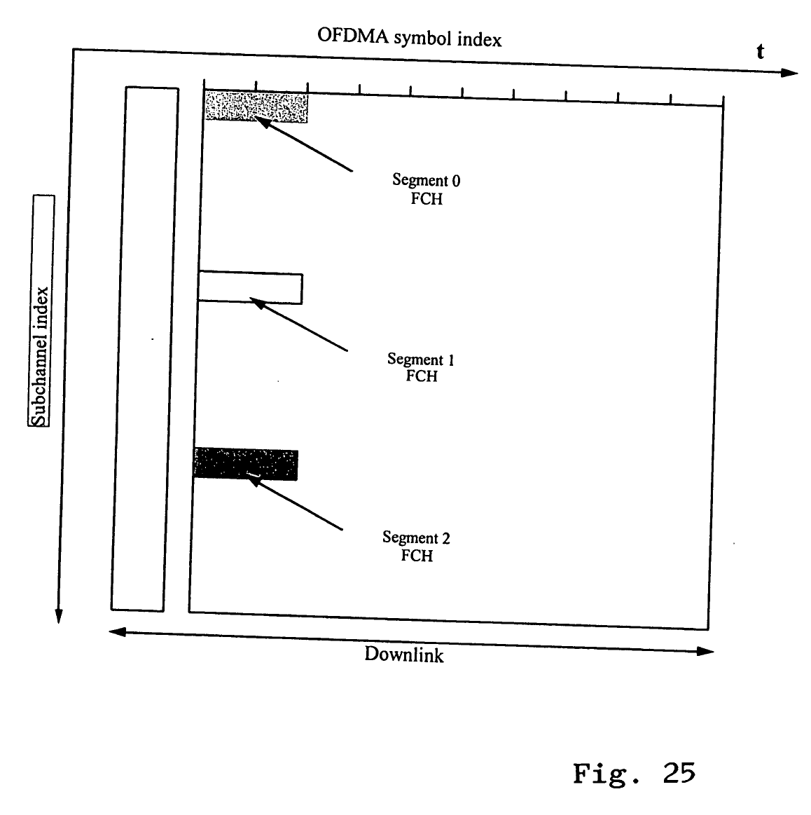

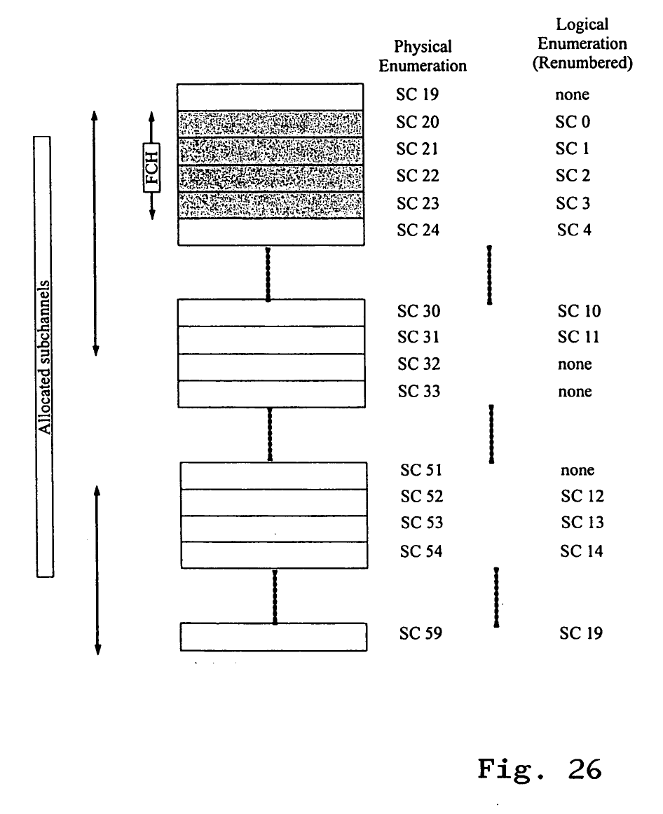

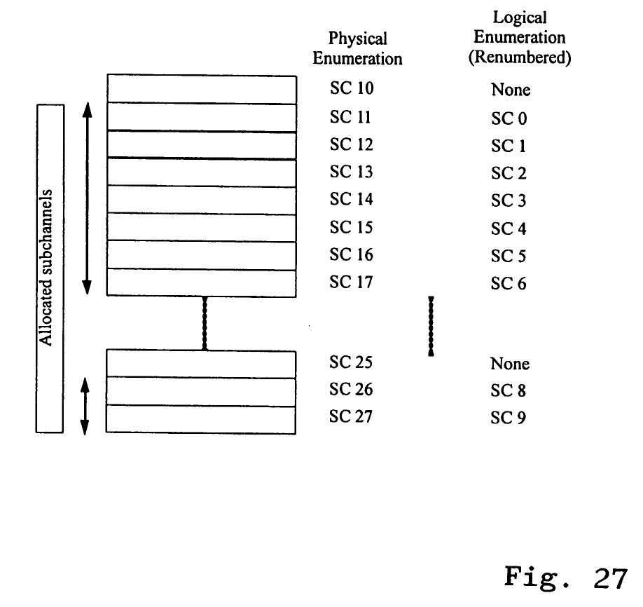

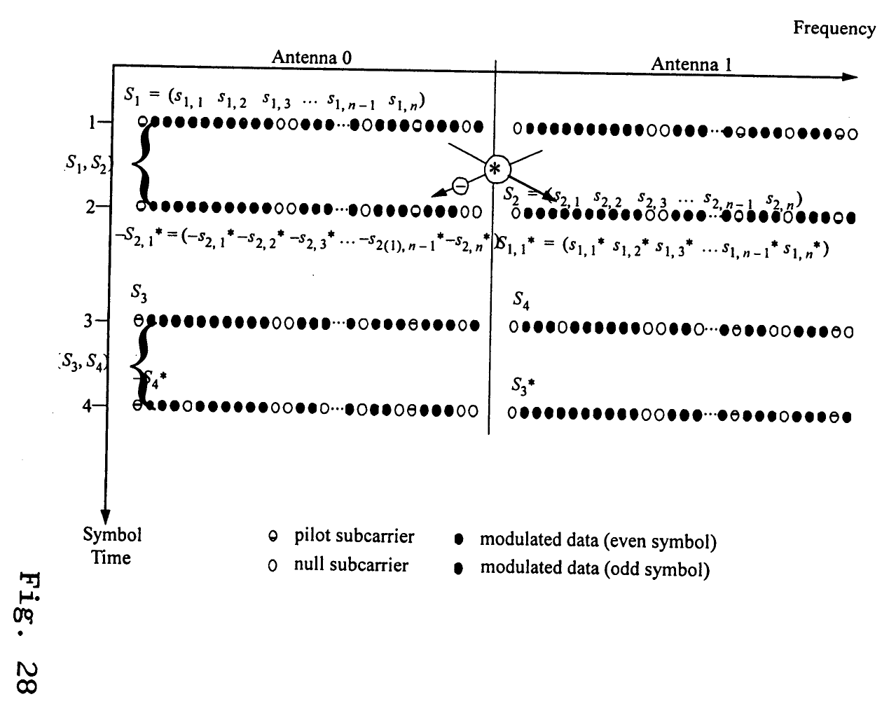

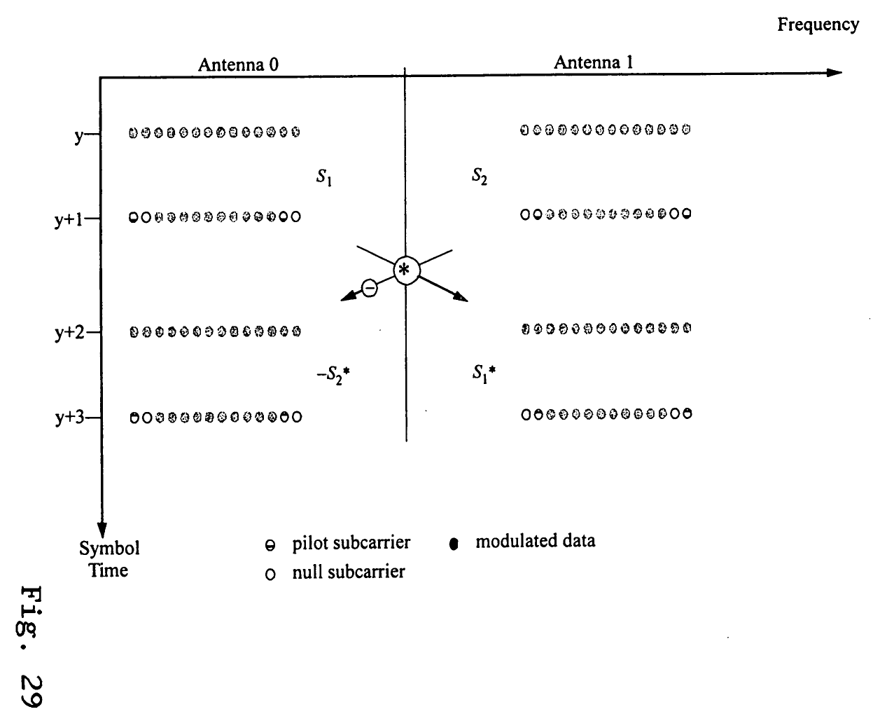

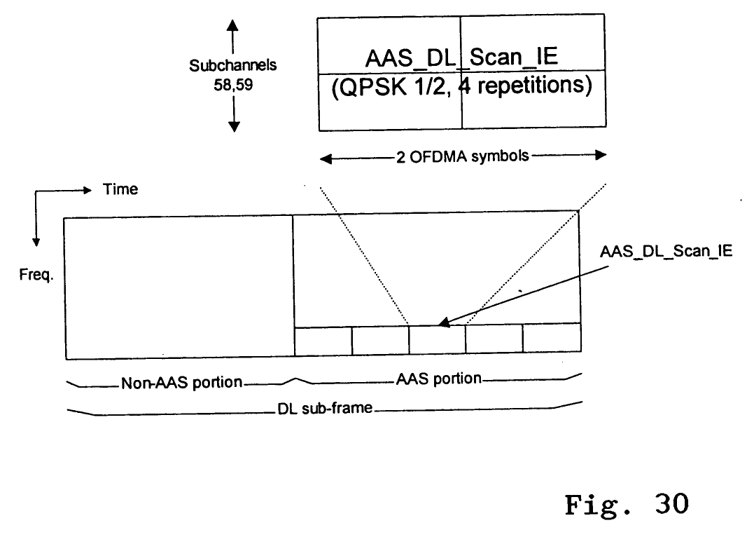

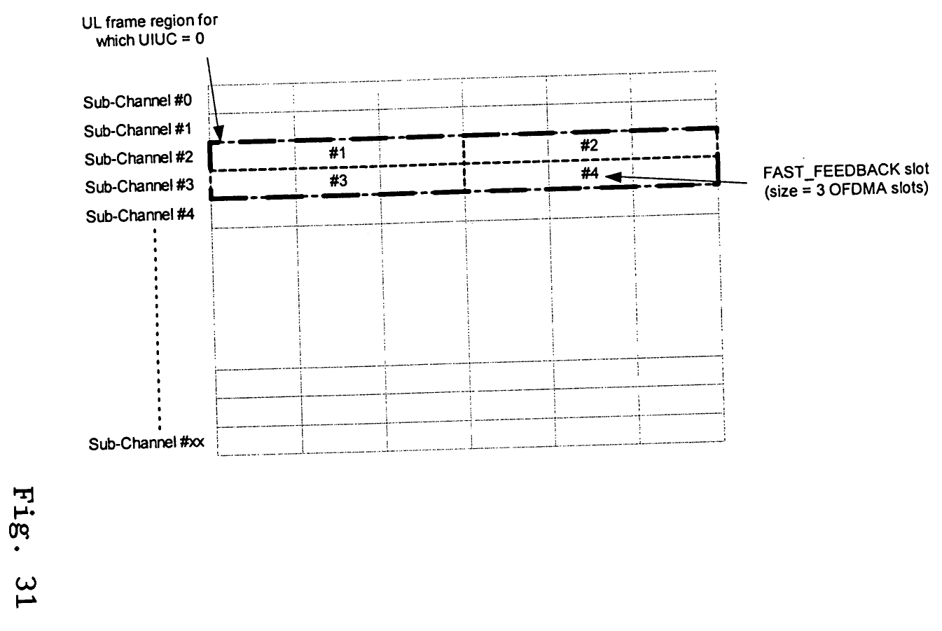

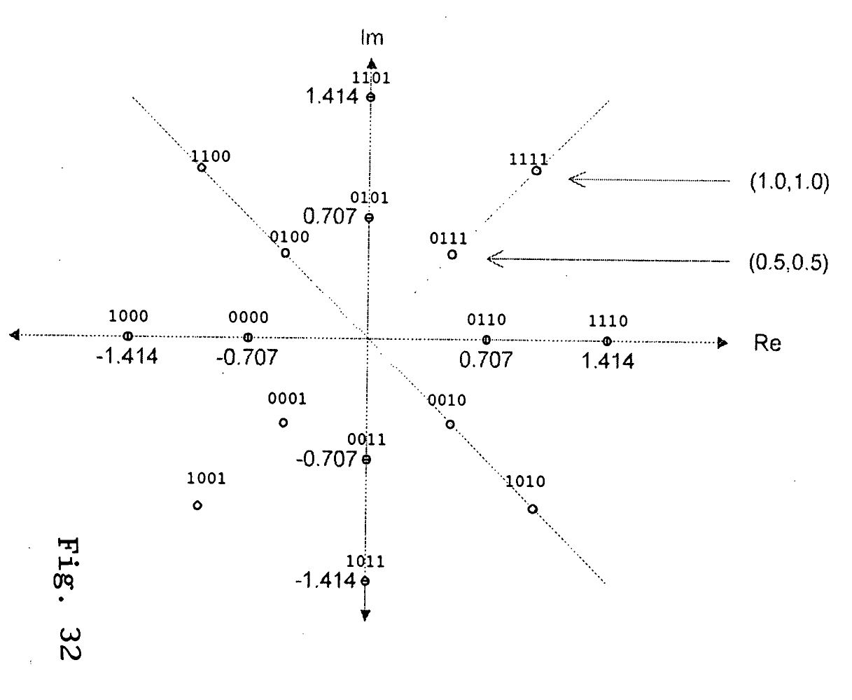

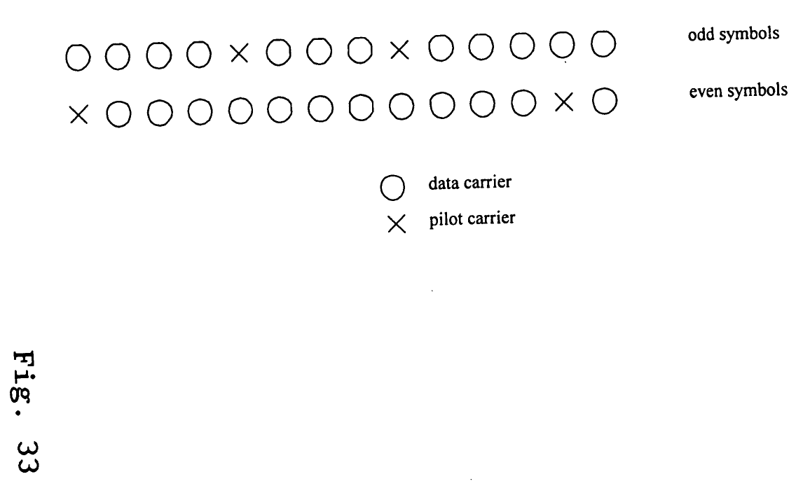

The description below, together with FIGS. 13 to 33, is an addition not contained in the priority Israel patent application and PCT application. Part of the material has been disclosed by the applicant before the IEEE 802.12 Working Group on Broadband Wireless Access, during the last 12 months.

It will be recognized that the present disclosure is but one example of an apparatus and method within the scope of the present invention and that various modifications will occur to those skilled in the art upon reading the disclosure set forth hereinbefore.

What is claimed is:

1. A soft handoff system for a wideband wireless cellular network, comprising diversity reception enhancement means, channel equalization for coherent processing means and coherent summing means.

2. The soft handoff system according to claim 1, wherein the downlink system further includes means for implementing diversity, allowing two base stations to concurrently transmit the same information, with coherent summing at the mobile receiver.

3. The soft handoff system according to claim 1, further including means for allocating a larger bandwidth to a mobile in the handoff region.

4. The soft handoff system according to claim 3, further including means for saving system resources by reducing instabilities and unnecessary multiple switching of base stations.

5. The soft handoff system according to claim 1, further including means for performing channel estimation for each of several channels, means for correcting the data in each channel and for summing the received information for reception improvement by diversity.

6. The soft handoff system according to claim 1, further including means in the uplink for concurrent reception of a mobile in two base stations, including the presently assigned contact for that mobile, as well as a potential base station to tranfer to.

7. The soft handoff system according to claim 6, wherein using these receptions and coordination between base stations to achieve a smart, planned, more effective handoff.

8. A soft handoff method for a wideband wireless cellular network, comprising:
1) The mobile subscriber continuously evaluates the quality of the channel; When it deteriorates, the mobile requests a handoff;
2) The base station activates diversity transmissions from one or more additional base stations, which transmit the same messages/packets to the mobile; The subcarriers allocation is tranmsitted to the mobile;
3) The mobile adds coherently the receptions from two or more base stations, for improved SNR; The mobile evaluates the quality of reception from the original base station and from the additional base station;
4) When the reception from the additional base station is reliable and above a preset quality level, the receiver is assigned to that base station and the diversity transmissions end.

9. A soft handoff method for a wideband wireless cellular network, comprising:
1) The mobile subscriber continuously computes its location or his SNR; The location or SNR is reported to the base station;
2) The base station and the mobile continuously evaluate the situation, to decide whether a handoff is required:
a. if the mobile nears the boundary to another cell, as indicated in its measured location/SNR
b. if the quality of service deteriorates
3) When a handoff is deemed necessary, the base station coordinates diversity transmission, for also sending messages/packets to the mobile from a second base station, or possibly from more than one additional base station. Each base station will use a different channel, comprising a different group of pilots;
4) The distance to the other base stations is measured, and the location of the mobile. If there is no good reception from the additional base stations, other paths may be activated—another base station, or another sector from the second base station. Thus, one or more alternate channels to the mobile are established.
